(19) United States
(12) Patent Application Publication
(10) Pub. No.: US 2019/0343711 A1
(43) Pub. Date: Nov. 14, 2019

(54) COMPRESSION THERAPY DEVICE

(71) Applicant: TTP Plc, Royston, Hertfordshire (GB)

(72) Inventor: Peter lee CROSSLEY, Comberton, Cambridgeshire (GB)

(21) Appl. No.: 15/999,521

(22) PCT Filed: Feb. 20, 2017
(86) PCT No.: PCT/GB2017/050428

§ 371 Date: Aug. 17, 2018

(30) Foreign Application Priority Data
Feb. 19, 2016 (GB) 1602910.0

(51) Int. Cl. A61H 9/00

(52) U.S. Cl. CPC A61H 9/0078; A61H 2230/62; A61H 2201/1635; A61H 2201/164; A61H 2201/1645; A61H 2201/165; A61H 2201/1654; A61H 2201/169; A61H 2201/5061; A61H 2201/5097; A61H 2205/062; A61H 2205/084; A61H 2205/106; A61H 2205/108; A61H 2205/12; A61H 2209/00; A61H 2230/06; A61H 2230/30; A61H 2201/0192

(57) ABSTRACT

An compression therapy device which improves on available products by combining the efficacy of bulky, active pneumatic devices with a convenience approaching that of a passive non-pneumatic device. This is achieved by using an air cell (6) with a flexible inner and a rigid outer wall (10) which enables therapeutic pressures to be achieved at lower overall inflation volume. This in turn allows miniature low power, silent pump (3) to be used enabling the device to be worn unobtrusively under clothing. Such a device is targeted at users with long term chronic venous conditions, variants of oedema, recovering from surgery, requiring travel comfort, improved leg circulation or accelerated recovery from exercise or injury.

### RELATED APPLICATIONS

The present application is a national stage application under 35 U.S.C. § 371 of International Application No. PCT/GB2017/050428, filed 20 Feb. 2017, which claims priority to Great Britain Patent Application No. 1602910.0, filed 19 Feb. 2016. The above referenced applications are hereby incorporated by reference into the present application in their entirety.

### FIELD

The present invention relates to consumer health and therapy devices, more specifically intermittent pneumatic compression therapy devices for promotion of venous and lymphatic flow within a form-factor able to be worn discreetly under clothing.

### BACKGROUND

Using externally-applied pressure around a muscle group is an established method for promoting the flow of fluid through the venous and lymphatic systems. This has several benefits, including: avoiding haemostasis (absence of blood flow) which is important in minimising the risk of thromboses (blood clots); reducing the build-up of lymphatic fluid (oedema) which causes painful and immobilising swelling; and promotion of blood and lymphatic flow to aid in recovery from exercise, injury or chronic wounds (in particular leg and foot ulcers).

Several products and treatments exist across the hospital, consumer health and physiotherapy sectors which aim to address some or all the issues outlined above. These can be generally categorised as one of the following.

Chemical prophylaxis, in the specific field of thrombosis prevention, usually post-surgical.

Electrical nerve stimulation devices which operate by stimulation of muscle contraction, causing outflow of fluid. Such devices (e.g. Firefly and Revitive) are becoming prevalent in the consumer health sector, which indicates that consumer appeal and usability are becoming more important as therapies move outside of controlled use within hospitals. Discreet, ambulatory devices (such as Firefly) hold advantages here over devices (such as Revitive) which require the user to remain seated.

Compression devices which apply pressure directly to the muscle group in order to cause fluid flow away from the area under pressure. Such devices are further sub-divided into passive or active devices.

Passive devices include elastic stockings, bandages or wraps. These range from disposable inexpensive garments for post-surgical use to heavily branded washable products marketed to amateur and professional athletes.

Active devices (often classed as Intermittent Pneumatic Compression, IPC) usually comprise one or more cells or air cells contained within a garment which are inflated using a pneumatic pump. These devices range from medical devices for post-surgical use with disposable garments and large reusable external pump unit, to reusable garments (again with external pump) marketed to elite athletes for post-training recovery.

Passive devices require correct fitting in order to impart an appropriate pressure to the muscle group under treatment, and are relatively inexpensive. Fundamental limitations of such devices are that achieving the correct pressure is dependent on garment fit and user skill, and that the pressure they apply cannot be cycled or controlled. This limits efficacy, especially in cases where the user is sitting or lying down. The majority of existing passive devices require the user to fit an elastic stocking over the foot, which has been shown to be challenging for less mobile users.

While walking, the natural action of, for example, the calf muscle group will impart the fluid pumping effect being sought, but this is largely lost while the user is static. For example, it is seen that the flow rate of blood returning via the femoral vein with a resting user is similar both with and without a static compression on the calf muscle.

Active devices are able to vary and cycle the pressure applied, which improves efficacy by mimicking the aforementioned pumping effect of the calf muscle, even with a resting user. However, available products are relatively expensive and in particular they are bulky, usually to the extent that the user must remain sitting or lying. This is due to both the bulk of the garment and its inflated air cell and the fact that the large, noisy and heavy pumping unit is separate to the garment.

A more compact device with pumping unit integrated onto the garment (DJO VenaPro) exists in the medical market and has appeal in that it allows relatively unobtrusive wear following hospital discharge. However, noise and bulk of this unit is still incompatible with daily, discreet, ambulatory wear, especially under clothing. No products currently exist in the medical or consumer healthcare market which combine the efficacy of available active pneumatic devices with the form-factor necessary for unobtrusive wear and, importantly, the size, weight and silence necessary for wide patient acceptance and consumer appeal as a desirable, reusable, product.

Pumping technologies are advancing, leading to reduced sizes for given performance. This is being achieved both in terms of evolution of existing pump technologies (for example motor-driven diaphragm pumps) and more recently the emergence of novel technologies which offer more significant improvements in performance for a given size. Such devices, in particular resonant piezoacoustic devices, offer additional benefits for consumer products, particularly low noise, even silence within the human hearing range.

Efficacy of compression therapy is related directly to the pressure applied to the muscle, rather than the volume inside the inflated air cell. Existing devices use a large volume air cell to deliver the required pressure. US 2014/0303533 describes such a flexible, inflatable wrap comprising an inflatable air cell and flexible inner and outer walls. The current state of the art thus deploys a flexible air cell which is cheap to manufacture, enables a single device to be flexibly shaped around a variety of limbs of various sizes and is somewhat self-regulating. However, flexible air cells are able to expand away from the targeted limb as well as towards, increasing the volume flow required to be pumped into the air cell to achieve a given pressure increase. This approach leads to a bulky and somewhat obtrusive device.

There appears to be an absence of motivation in the prior art to minimise air cell volume to achieve a therapy pressure. Those skilled in the art of compression therapy device design are motivated by medical utility rather than convenience or aesthetics. Additionally, the large pumping units in the prior art have dictated a somewhat bulky form factor, resulting in the lack of any motivation to reduce the size of the air cell. In any case, those skilled in the art have not so far implemented any designs which provide a truly wearable product.

### SUMMARY

According to the present invention there is provided a compression therapy device comprising:

a flexible air cell arranged to be placed on a user's skin in use;

a rigid shell arranged to be positioned on the air cell on a side opposite a user's skin in use; and

a garment arranged around the shell and configured to retain the air cell in close engagement with the user's skin in use.

The present inventors have designed an active compression therapy device comprising an inflatable air cell having a rigid outer shell. The inflatable air cell can comprise a single segment or multiple segments, but most importantly it is substantially smaller in inflated volume than prior art air cells while delivering therapeutic pressure to the treated limb. The rigid outer shell avoids the outward-facing face of the air cell expanding away from the body while inflating, which would be inefficient in terms of reaching therapeutic pressure quickly. The resulting device is significantly more compact than prior art devices but has also proven to be simple to fit, by virtue of its more rigid structure. The combination of shell and air cell enables the use of a smaller, lower power, quiet pump. Surprisingly, the use of an appropriately shaped rigid outer shell gives rise to substantial potential benefits of size, weight, battery life and noise.

An aesthetic improvement to existing devices is gained by using an air cell designed to enable the necessary pressure to be reached with a substantial reduction in the volume of the air cell. This enables a low profile device to be designed which is small enough to fit in an unobtrusive manner under clothing.

State of the art devices often use multiple-segment air cells within the garment in order to provide sequential or graduated compression using a system of valves attached to the pump. Such devices may span joints in the limb and as such reduce the mobility of the user.

The present invention is compatible with such arrangements, but also offers an alternative to improve mobility. The compact nature of the pumping device and the possibility for wireless control allows separate devices to be worn on different parts of the body, with sequential or graduated pressure cycling profiles coordinated between the devices by a control device, which may be embedded within one of the devices or an external control device such as a smartphone application. Known communication technologies such as WiFi, Bluetooth, Zigbee or other, proprietary low-power radio technologies may be used to enable individual devices to communicate with each other and/or with such a control device.

The garment may be machine-washable, enabled for example by separating the air cell, shell and pumping unit from the garment, or by disconnecting the pump unit only and sealing the entry port to the air cell.

The present invention therefore combines novel pumping technologies with novel product design resulting in effective, easy to use, desirable compression therapy device suitable for the medical, consumer health and fitness sectors. The appeal and access to such can be widened across many use cases and demographics, for example:

Post exercise recovery for active people; post injury or surgery treatment; circulation promotion and healthy-feeling legs for those spending extended time driving vehicles, riding motorcycles or during air travel; and swelling reduction for those with either primary or secondary oedema to encourage a virtuous circle of more activity and improved health. A significant burden on health systems is the ongoing treatment of chronic lower leg wounds, in particular leg and foot ulcers. Research shows that Intermittent Compression Therapy can be beneficial in recovery from such wounds. The present invention is particularly beneficial here, since it allows unobtrusive use for the long treatment period associated with such conditions.

### DESCRIPTION OF THE DRAWING FIGURES

Examples of the present invention will now be described with reference to the accompanying drawings, in which:

FIG. 1 is a schematic view of a device according to the present invention attached to a user's lower leg;

FIG. 2 shows a schematic view of the pumping unit.

FIG. 3 is an expanded view of a device according to the present invention showing the relative locations of a shell and air cell and other components of the device;

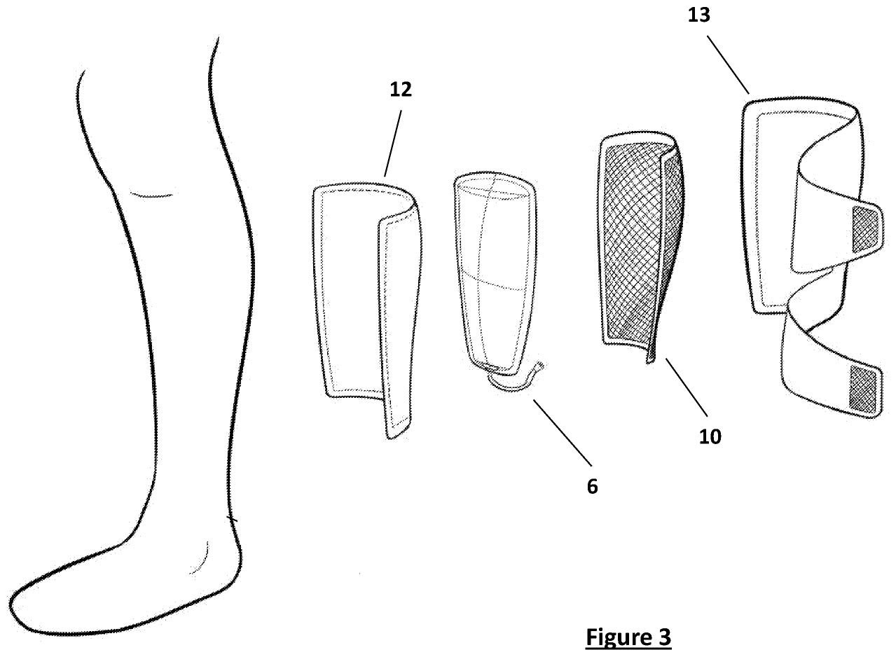

FIG. 4 is a sectional view of a shell and an air cell according to the present invention;

FIG. 5 shows an example shell construction that may be employed with the present invention.

FIG. 6 shows an example product embodiment comprising separable sub-assemblies.

### DETAILED DESCRIPTION

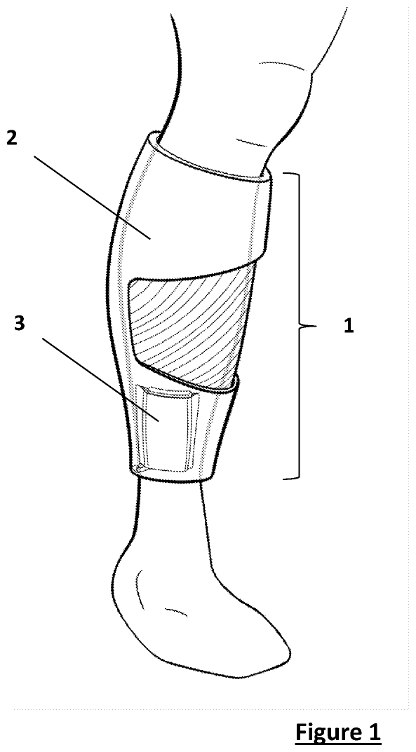

Referring to FIG. 1, a device 1 according to the invention comprises two assemblies, a garment 2 and a pumping unit 3.

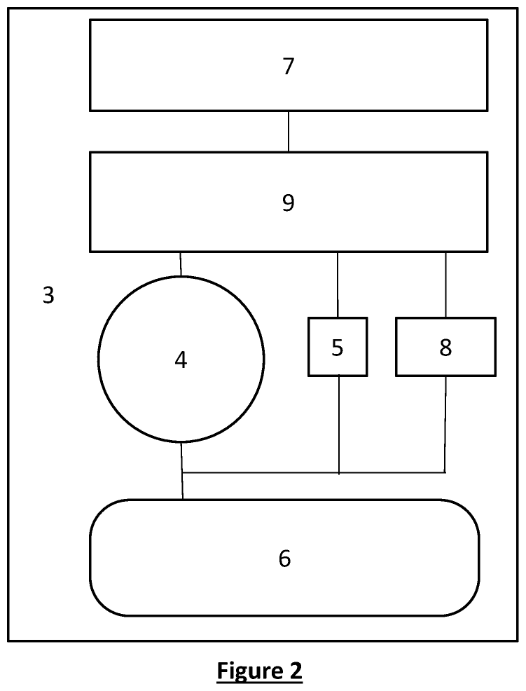

Referring to FIG. 2, The pumping unit 3 may be a mechanically separate subassembly, or, as shown in FIG. 1 be tightly integrated with the garment 2, but in either case it typically contains: a pump 4, a pressure sensor 5 pneumatically connected so as to measure air pressure within an air cell 6, a battery 7, a vent valve 8 to permit the air cell 6 to be emptied to atmosphere, and control electronics 9 to co-ordinate operation of the pump 4, vent valve 8, battery 7 and pressure sensor 5.

The garment 2 comprises three functional components, which are first briefly defined below, then the functionality and manufacturing options are further explained.

An air cell 6 is formed from a single or segmented air-tight bag-like structure, pneumatically connected to the pumping unit 3. If segmented it may be arranged so that segments can be inflated and deflated sequentially.

A shell 10 is formed from a rigid structure which is arranged immediately outboard (with respect to the user's body) of the air cell 6.

A garment 2 is provided and serves to hold the shell 10 and air cell 6 in place on the user. It may be formed from fabric.

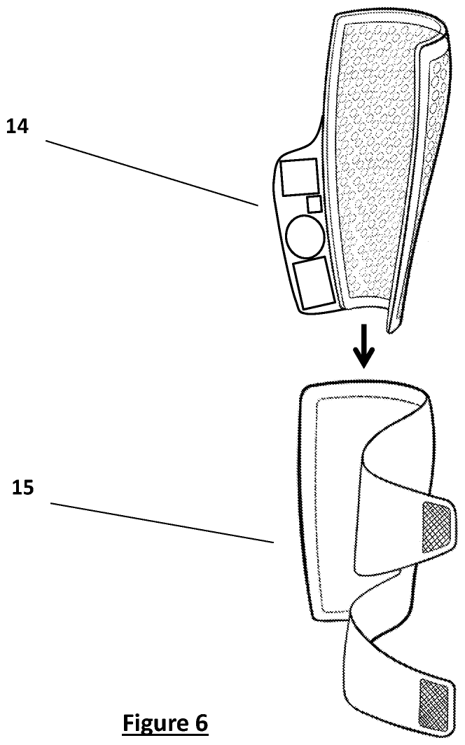

Referring to FIG. 6, an alternative embodiment of the device is to configure the pump unit, shell and air cell and an integrated, non-washable sub-assembly 14, and provide a pocket within a washable (or disposable) garment 15 which securely and removeably locates the aforementioned integrated sub-assembly.

The combination of air cell 6 and shell 10 is significant. The air cell wall facing the user's body in use is thin and flexible in order that it may freely inflate and spread therapy pressure evenly over the entire area over which it presses against the user. However, flexibility on the opposite wall, away from the user only serves to increase air cell volume, so the invention restricts this by having the air cell 6 bear against a rigid shell structure 10. The shell structure 10 is shaped to fit the body part under treatment, which serves to minimise the ‘free volume’ between air cell 6 and user which would need to be filled by pumping in air.

There are aspects of the shell structure which may be provided alone or in combination with one another:

A double-curvature may be provided in order to fit the user's body most closely. This is of benefit in most body parts, however a single curvature may approximate the body well enough in the case of some limbs (for example the forearm).

The shell stiffness should be selected so as not to distort significantly when pressures of up to approximately 100 mmHg are applied from the inside (the double concave side). Note that this pressure when applied locally from the outside (doubly convex) would most likely buckle the structure. Operating pressure range would be between 10 and 100 mmHg, most typically between 40 and 70 mmHg would be used to combine user comfort with efficacy.

There should be enough flexibility to allow the shell 10 to conform around the body when restrained by the garment while fitting.

It has been shown during development that an appropriately designed shell 10 is possible which has enough general flexibility to fit to the body and enough stiffness to effectively avoid the air cell 10 flexing the shell significantly away from the body during inflation. It has been further shown that, while the shell 10 may be custom made to fit a user for optimum fit (and hence minimise wasted air cell volume), enough effectiveness may be achieved by producing a sub-set of shell sizes to fit a range of user sizes. A range comprising small-medium-large, for example, as would be familiar to sportswear consumers, has been found to be sufficient to encompass most potential users. Adding additional sizes (extra small-extra large for example) is simply a question for commercial consideration.

In terms of effectiveness, the time taken to reach a typical therapy pressure of 50 mmHg (using the same pump unit) is reduced by approximately 40% with the invention when compared to prior art devices. This is a highly beneficial reduction when one considers the power consumption advantage of a much reduced pumping time, which can be capitalised upon in terms of increasing battery life and/or enabling a small pump to be used. A second benefit clearly shown is a reduction in product bulk when inflated, to the benefit of wear under clothing. A still further surprising benefit of reduced pumping time is that it gives the user the option to carry out a greater number of completed pumping cycles (pump, then vent) within a given time. This allows greater efficiency of treatment over the prior art, whereby more blood or lymph flow is created per unit time of product use.

Manufacturing options for the air cell 6 and shell 10 include an air cell produced entirely from flexible material (for example polyurethane sheet, cut then heat-sealed), then affixed to a separately-made shell 10 or an integrated air cell and shell whereby a flexible body-facing (inner) layer is affixed to the more rigid outer layer, where both layers are air-tight.

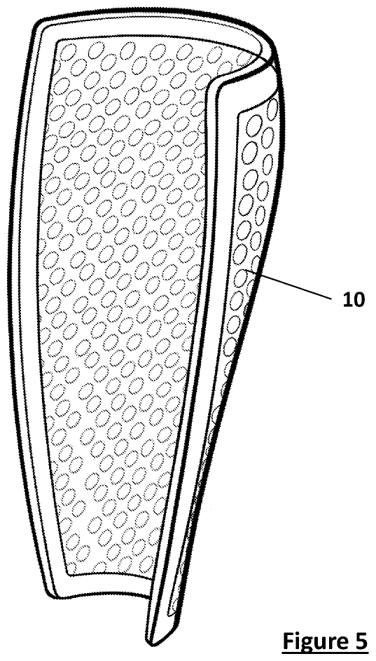

For the shell 10 specifically, it has been shown that suitable combinations of shape and mechanical properties can be achieved by using perforated thermoplastic sheet (for example polypropylene, polyethylene or polycarbonate) which can be manufactured in sheet form, then thermally formed around a suitable mould to the desired shape. The perforations in the material allow the double-curvature to be formed more readily, while reducing weight. This is shown in FIG. 5.

The use of 2 mm thick unreinforced polypropylene sheet with a hexagonal array of 8 mm diameter perforations has shown to have the necessary stiffness properties to allow a shell design which requires perhaps three variants to cater for the likely range of user sizes.

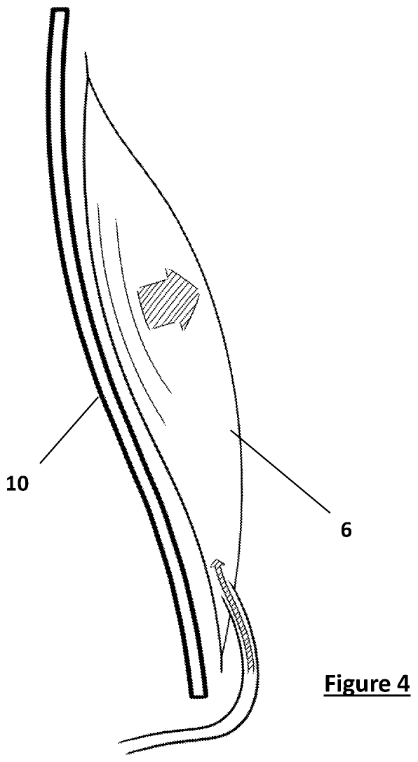

Alternatively, a non-perforated material may be used, which allows more ready integration with the air cell 6, and suits a vacuum- or blow-forming process, as shown in FIG. 4.

It is possible to achieve the desired combination of properties using other manufacturing methods, for example injection moulding of a suitable thermoplastic (for example polypropylene, nylon or ABS). Other materials are also possible, for example sheet metal mesh or reinforced thermosets (of which carbon, fabric and glass reinforced materials are examples).

The stiffer the shell structure, the more custom the fit needs to be to the user in order to ensure comfortable fit and effective inflation performance. The objectives and benefits of the present invention are therefore applicable to a wide range of shell stiffnesses and manufacturing techniques, since each will show different combinations of conformability to the user and inflation time properties. As a guide, the stiffness of a shell design according to this invention could range from that offered by a 1 mm thick polyethylene perforated sheet, to that of a non-perforated metallic or carbon-fibre reinforced resin sheet.

The selection of material, thickness and detail design of the shell is therefore a compromise between manufacturability, stiffness, weight, comfort and fit. As a guide, the following table illustrates three options available and their general characteristics:

| | | Level of | | |
|---|---|---|---|---|
| | | customisation | | |
| | | required to | Cost of | |
| | | achieve proper fit | manu- | |
| Material | Stiffness | and function | facture | Weight |
| 1 mm thick | Low | Low | Very low | Very low |
| unreinforced | | | | |
| thermoplastic | | | | |
| 2 mm thick | Medium | Medium | Low | Low |
| glass-reinforced | | | | |
| thermoplastic | | | | |
| Carbon | High | High | High | Low |
| reinforced | | | | |
| thermosetting | | | | |
| resin | | | | |
| Aluminium | High | High | Medium | Medium |

The design of the garment 2 which locates the air cell 6 and shell 10 on the user uses combinations of fabric and fasteners so as to achieve ease of use, proper fit and function.

An important function of the garment 2 is to locate the shell 10 against the user in such a way that the present invention may be realised. As the air cell 6 fills, the whole shell 10 (even without local flexing) will tend to move away from the user. This movement increases the volume required to achieve the target pressure and therefore the benefit of using the shell 10 is compromised.

Therefore, the garment 2 must have a sufficiently close fit and be of stiff enough material in the circumferential direction to minimise the movement of the shell. The compromise to be made here is in achieving enough circumferential stiffness which still achieving a compliant, comfortable fit.

Prior art (US 2014/0303533) achieves this by using garment material with different levels of stiffness (or elongation for a given tensile force) in two orthogonal directions. A high stiffness (low elongation) is used circumferentially around the limb, and low stiffness (high elongation) is used along the length of the limb. This combination is very effective and has shown to be suitable for the present invention.

The present invention can be applied equally to many areas of the body, for example on muscle groups of the calf, thigh, forearm, upper arm, shoulder and chest. Additionally, the invention may be applied to garments intended to span knee, ankle and elbow joints, and the foot.

Another example of the present invention is to use a combination of separate devices 1 of the types described above, worn on different parts of the body simultaneously. In these cases, it would then be possible to co-ordinate the action of each device 1 through the control electronics 9. Sequential inflation is of benefit when treating the leg or arm. With the present invention, sequential inflation can be achieved by wirelessly co-ordinating separate devices through the control electronics 9.

Such an arrangement avoids the need for cumbersome interconnected garments which span joints and therefore restrict movement, and also removes the need for active valve systems.

The control electronics 9 may include a microprocessor, a pressure sensor 5, and battery-charging control. The battery 7 may be a low-profile lithium type. A wireless system may optionally be provided to allow the device to be controlled remotely, for example via a smartphone application.

1. A compression therapy device comprising:
a flexible air cell arranged to be placed on a user's skin in use;
a rigid shell arranged to be positioned on the air cell on a side opposite a user's skin in use; and
a garment arranged around the shell and configured to retain the air cell in close engagement with the user's skin in use.

2. The device of claim 1, wherein the air cell and shell are integrated with one another.

3. The device of claim 1, further comprising a pump pneumatically connected to the air cell.

4. The device of claim 1, wherein the pump is separable from the air cell.

5. The device of claim 3, wherein the pump is a resonant piezo-acoustic pump.

6. The device of claim 3, further comprising control means for controlling the pump to control the pressure in the air cell.

7. The device of claim 1, arranged to treat at least one of a user's upper or lower legs or arms, shoulder, feet, ankles and torso.

8. The device of claim 1, wherein the shell is shaped to have a double curvature.

9. The device of claim 1, further comprising means to control a therapy cycle wirelessly according to user preferences.

10. The device of claim 1, further comprising means to communicate usage data to a remote host.

11. The device of claim 1, arranged to measure at least one of:
the user's heart-rate;
the user's blood pressure; and
the position of the part of the body to which the device is attached.

12-13. (canceled)

14. A compression therapy system comprising:
first and second compression therapy devices, each device including:
a flexible air cell arranged to be placed on a user's skin in use;
a rigid shell arranged to be positioned on the air cell on a side opposite a user's skin in use; and
a garment arranged around the shell and configured to retain the air cell in close engagement with the user's skin in use; and
means to control the first and second devices to provide coordinated pumping action therebetween.

15. The compression therapy system of claim 14, further comprising means to control a therapy cycle for each of the first and second devices wirelessly according to user preferences.

16. The compression therapy system of claim 15, wherein the means to control the first and second devices wirelessly controls at least one of the therapeutic cycles of the devices and the co-ordination of the therapy between the devices.
